(19) United States
(12) Patent Application Publication
(10) Pub. No.: US 2010/0200605 A1
(43) Pub. Date: Aug. 12, 2010

(54) Blow Molded Plastic Container Assembly With Improved Lid Sealing

(75) Inventors: Walter R. Herring, Lancaster, PA (US); Kevin T. Hartman, York, PA (US); Kevin D. Himes, Mount Wolf, PA (US); Lawrence Korpanty, York, PA (US); Jana M. Zeigler, Erwin, TN (US); David B. Clements, Medina, OH (US)

Correspondence Address: KNOBLE, YOSHIDA & DUNLEAVY, EIGHT PENN CENTER, SUITE 1350, 1628 JOHN F KENNEDY BLVD, PHILADELPHIA, PA, 19103, US

(73) Assignee: Graham Packaging Company, L.P., York, PA (US)

(21) Appl. No.: 12/370,246

(22) Filed: Feb. 12, 2009

(51) Int. Cl. B65D 25/00; B29C 49/00

(52) U.S. Cl. 220/780; 264/531

(57) ABSTRACT

A plastic container that is preferably formed using a blow molding and trimming process includes a container main body portion and a lid mounting portion. The lid mounting portion includes a sealing flange and a flexible transition portion connecting the sealing flange to the container main body portion. The flexible transition portion preferably has at least one notch defined therein so as to form a hinge permitting downward movement of the sealing flange when a lid is secured on to the container. In another embodiment, more than one notch is provided defining multiple hinges that provide a compound hinge effect in order to reduce stresses on the molded plastic material during use of the container.

### BACKGROUND OF THE INVENTION

1. Field of the Invention

This invention relates generally to the field of plastic containers, and more specifically to plastic containers that are designed to receive a snap fit lid that forms a seal with the container for securing product within the container.

2. Description of the Related Technology

Containers for compositions such as paint and similar substances are required to be designed so as to ensure that a reliable and secure seal is formed between the container and the lid. Such as seal is required not only to prevent spoilage of the contents of the container, but also to prevent potentially harmful vapors from escaping the container assembly during transportation and storage. Such containers also must be constructed so as to have high degree of reliability and durability under extreme temperature conditions and for prolonged periods of storage.

Accordingly, paint containers conventionally have been fabricated from steel or other metallic materials and have utilized lids that also were fabricated from a metallic material. The use of plastic materials for such applications has also been proposed. However, it has been difficult to achieve the required sealing and performance characteristics that are briefly described above using plastic containers.

However, plastic containers offer benefits in terms of economy of manufacture, shapeability and lightweighting that make them potentially attractive for use as paint containers if the prerequisite sealing and performance characteristics can be achieved. Accordingly, a need exists in this area of technology for an improved plastic container assembly for packaging paints and similar materials that possesses a high degree of reliability and durability under extreme conditions and that ensures that a reliable and secure seal is formed between the container and the lid.

### SUMMARY OF THE INVENTION

Accordingly, it is an object of the invention to provide an improved plastic container assembly for packaging paints and similar materials that possesses a high degree of reliability and durability under extreme conditions. It is also an object of the invention to provide an improved plastic container assembly that ensures that a reliable and secure seal is formed between the container and the lid.

In order to achieve the above and other objects of the invention, a plastic container according to a first aspect of the invention includes a container main body portion; and a lid mounting portion, the lid mounting portion including a sealing flange and a flexible transition portion connecting the sealing flange to the container main body portion, the flexible transition portion having at least one notch defined therein so as to form a hinge permitting downward movement of the sealing flange.

A method of making a plastic container according to a second aspect of the invention includes steps of blow molding a container blank having a main body portion and a lid mounting portion, the lid mounting portion comprising a sealing flange blank and a flexible transition portion connecting the sealing flange blank to the container main body portion, the flexible transition portion having at least one notch defined therein so as to form a hinge; and trimming the sealing flange blank to form a sealing flange.

These and various other advantages and features of novelty that characterize the invention are pointed out with particularity in the claims annexed hereto and forming a part hereof. However, for a better understanding of the invention, its advantages, and the objects obtained by its use, reference should be made to the drawings which form a further part hereof, and to the accompanying descriptive matter, in which there is illustrated and described a preferred embodiment of the invention.

### BRIEF DESCRIPTION OF THE DRAWINGS

FIG. 1 is a perspective view of a container assembly that is constructed according to a preferred embodiment of the invention;

FIG. 2 is a bottom perspective view of a lid member that is constructed according to the preferred embodiment of the invention;

FIG. 3 is a cross-sectional view showing a portion of the lid member that is depicted in FIG. 2;

FIG. 4 is a fragmentary cross-sectional view depicting a portion of the container assembly that is shown in FIG. 1;

FIG. 5 is a fragmentary cross-sectional view depicting a portion of a container assembly that is constructed according to an alternative embodiment of the invention;

FIG. 6 is a fragmentary cross-sectional view depicting a container blank that is constructed according to a preferred method of the invention and that corresponds to FIG. 3;

FIG. 7 is a fragmentary cross-sectional view depicting a container blank that is constructed according to an alternative method of the invention that corresponds to the embodiment that is depicted in FIG. 4; and

FIG. 8 is a flowchart depicting the method that is performed according to the preferred embodiment of the invention.

### DETAILED DESCRIPTION OF THE PREFERRED EMBODIMENT(S)

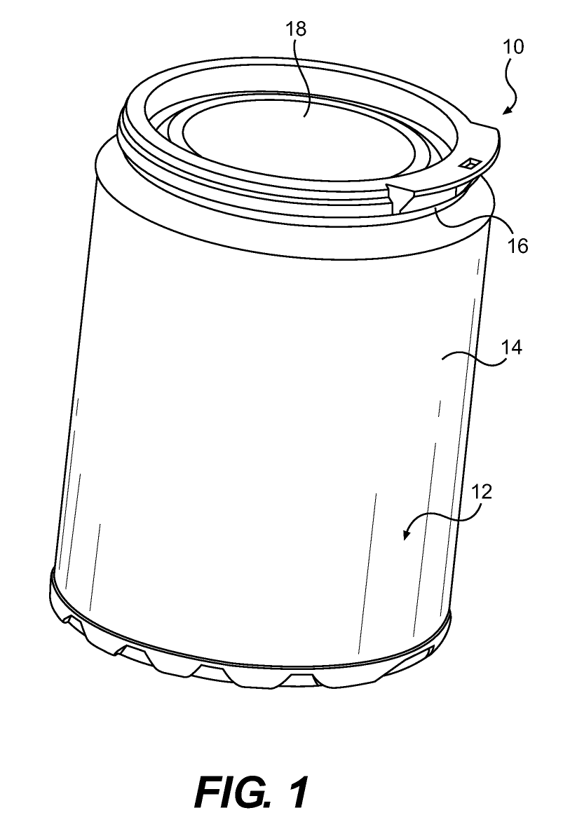

Referring now to the drawings, wherein like reference numerals designate corresponding structure throughout the views, and referring in particular to FIG. 1, a container assembly 10 that is constructed according to the preferred embodiment of the invention includes a blow molded plastic container 12 having a container main body portion 14 and an upstanding lid mounting portion 16 that will be described in greater detail below.

The blow molded plastic container 12 is preferably manufactured according to the extrusion blow molding process, and is preferably fabricated from a plastic material such as polypropylene, polyethylene or high-density polyethylene. The blow molded plastic container 12 may also be constructed from a multi-layer plastic material that is co-extruded as a multilayered parison and then is molded into the preferred container, preferably although not necessarily by using a shuttle or a wheel molding apparatus.

Container assembly 10 further includes a lid member 18, which is preferably fabricated from a plastic material such as polypropylene, polyethylene or high-density polyethylene. Lid member 18 may be fabricated from a softer material than is used to fabricate the blow molded plastic container 12, and may in the preferred embodiment be fabricated so as to have a wall thickness that is less than the wall thickness of the blow molded plastic container 12. The lid member 18 is preferably fabricated using an injection molding process.

Alternatively, the lid member 18 can be fabricated from a metallic material such as steel or aluminum.

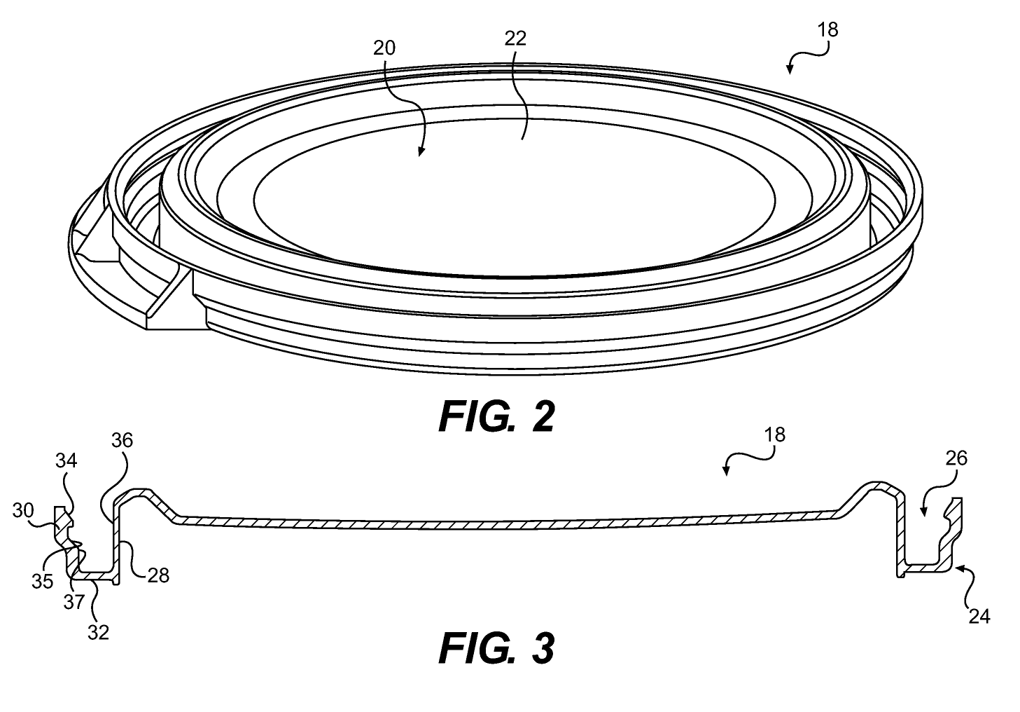

Referring to FIG. 2, lid member 18 preferably has a lower surface 20 that is configured so as to provide a recessed well portion 22 that can be used to store small amounts of liquid material from the container 12, such as small amounts of paint that could be used by painters for touchup purposes while completing a painting job.

As FIG. 3 shows, lid member 18 preferably has a mounting portion 24 that defines an annular recess 26 that is constructed and arranged to receive an upper portion of the upstanding lid mounting portion 16 of the blow molded plastic container 12 in a snap fit arrangement. The annular recess 26 is preferably defined by a substantially vertically oriented inner wall 28, a substantially vertically oriented outer wall 30 and a substantially horizontal a oriented top wall 32 that is unitary with both of the inner wall 28 and the outer wall 30. The entire lid member 18 is preferably fabricated so as to be a single unitary piece.

The outer wall 30 preferably includes at least one annular snap bead 34 that is provided on inner surface thereof in order to engage corresponding structure on the container 12 to facilitate a snap fit. Alternatively, a plurality of snap bead members 34 could be provided instead of a continuous annular bead. The inner surface of the outer wall 30 further includes an oblique contact surface 35 that is constructed and arranged to contact structure on the container 12 to facilitate the snap fit, as will be described in greater detail below. The oblique contact surface 35 intersects with an upstanding vertical portion of the inner surface of the outer wall 30 to define an annular sealing ridge portion 37, as is best shown in FIG. 3. The inner wall 28 includes an inner surface 36.

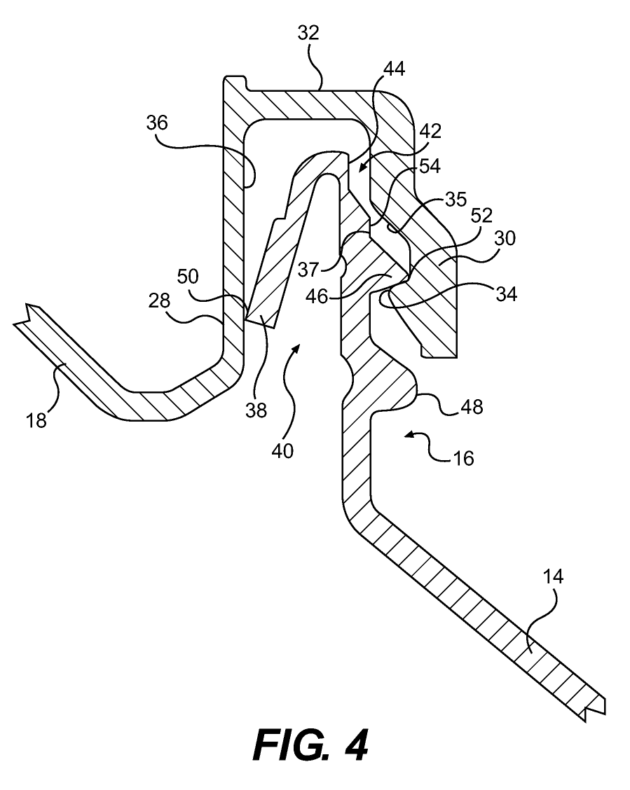

Referring now to FIG. 4, it will be seen that the lid mounting portion 16 of the blow molded plastic container 12 includes a sealing flange 38 and a flexible transition portion 40 that connects the sealing flange 38 to the container main body portion 14. The flexible transition portion 40 preferably includes at least one notch defined in the sidewall thereof so as to form a hinge permitting downward movement of the sealing flange 38.

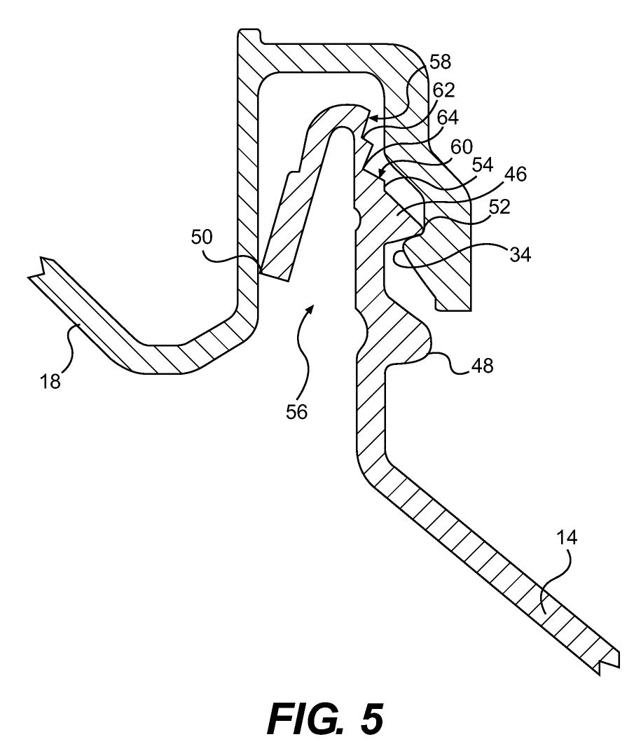

In the embodiment that is shown in FIG. 4, a single notch 42 defines a single hinge 44. In the alternative embodiment of the invention that is shown in FIG. 5, a first notch 58 defines a first hinge 62 and a second notch 60 defines a second hinge 64. In the embodiment of FIG. 5, the first and second hinges 62, 64 are spaced vertically from each other. This creates a compound hinge effect that reduces fatigue and stress on the individual hinges, prolonging the service life of the container assembly and improving its durability. Although two hinges 62, 64 are used in the preferred embodiment, more than two hinges could alternatively be used.

Referring back to the embodiment of FIG. 4, the flexible transition portion 40 further includes an annular radially outwardly extending mounting bead 46. A second bead 48 that is positioned below the mounting bead 46 also extends radially outwardly and reduces the clearance surface between the sidewall of the flexible transition portion 40 and the lowermost edge of the outer wall 30 of the lid member 18 in order to make it more difficult to accidentally pry the lid member 18 off of the container 12.

A first continuous annular or circumferential seal 50 is formed between the inner end of the sealing flange 38 and the inner surface 36 of the inner wall 28 of the lid member 18 in order to prevent leakage from the container 12. A second circumferential annular seal 52 is formed by the contact of the outermost portion of the annular mounting bead 46 and the inner surface of the outer wall 30 just beneath the oblique contact surface 35 in order to further prevent leakage from the container 12. In addition, a third circumferential contact area 54 may be created by the contact of the annular sealing ridge portion 37 of the inner surface of the outer wall 30 of the lid member 18 with a portion of the outer sidewall of the flexible transition portion 40 between the notch 42 and the annular mounting bead 46. The third circumferential contact area 54 in the preferred embodiment does not create a seal, although this may be possible in an alternative embodiment. The compound seal that is created by the individual continuous annular seals 50, 52 is expected to be comparable to the seal that is achieved using metallic paint container assemblies, and provides redundancy that will provide additional security against leakage that might otherwise occur due to unwanted deformation of the plastic material that is used to fabricate the lid member 18 and the container 12.

When the lid 18 is fastened onto the container 12, the flange 46 is preferably in contact with the lip 34, which holds the lid 18 onto the container 12.

The embodiment of the invention that is depicted in FIG. 5 is identical to the embodiment of FIG. 4 except that it is provided with a plurality of hinges 62, 64, as has been discussed above.

According to aspect of the invention, the hinge 44 in the embodiment of the invention that is depicted in FIG. 4 is constructed so as to have an average thickness that is less than about 0.025 inches, and that is more preferably less than about 0.20 inches. Thickness in the sense that the term is being used herein refers to the cross-sectional width as shown in FIG. 4 is measured in the horizontal plane that the point of minimum thickness. Forming the hinge 44 of limited thickness provides adequate flexibility so that the hinge 44 will absorb most of the movement of the sealing flange 38 as it is pushed downwardly when the lid 18 is snapped onto the lid mounting portion 16 of the container 14.

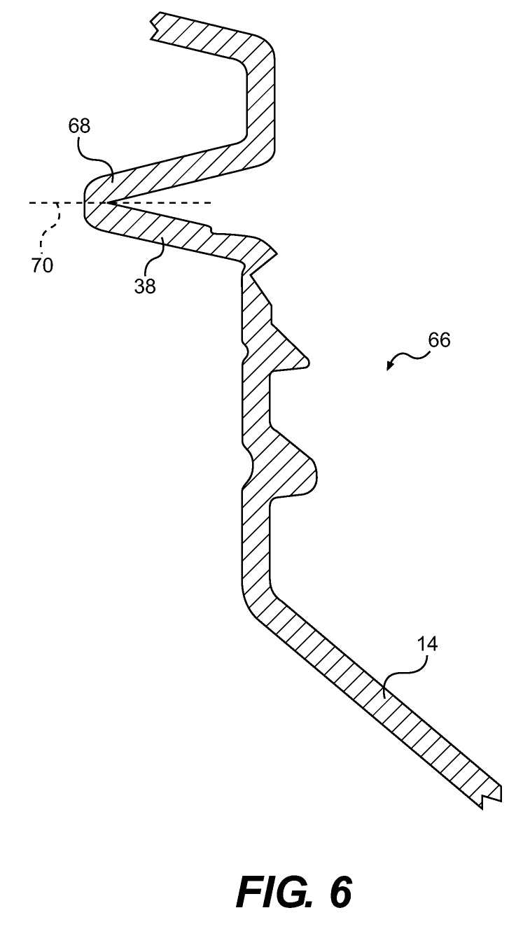

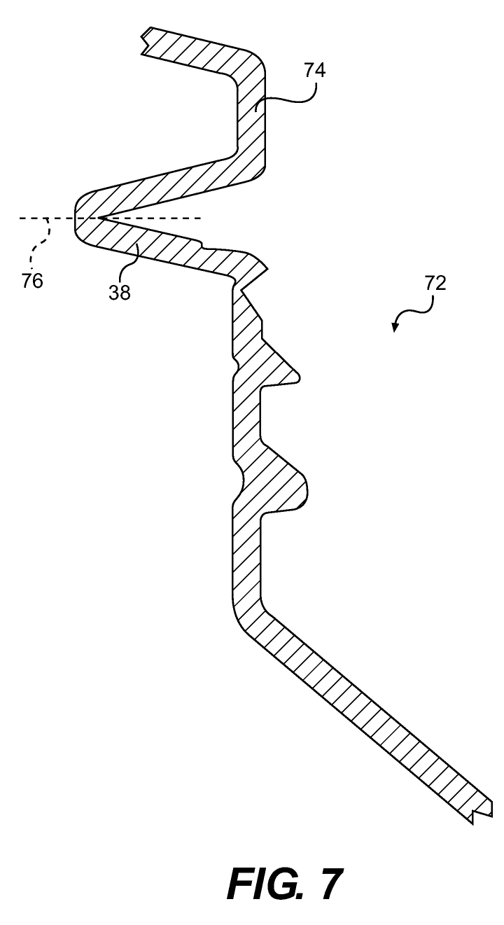

A making a blow molded plastic container according to one aspect of the invention is shown schematically in FIGS. 6-8. It includes, in the embodiment that is shown in FIG. 6, steps of blow molding a container blank 66 having a main body portion and a lid mounting portion, the lid mounting portion including a sealing flange blank 68 and a flexible transition portion connecting the sealing flange blank 68 to the container main body portion 14, and trimming the sealing flange blank 60 along a trim plane 70 to form a sealing flange. FIG. 7 shows the similar process that is performed on a container blank 72 that is used to fabricate a container having a flexible transition portion. It includes a sealing flange blank 74 that is trimmed along a trim plane 76.

Preferably, the sealing flange 38 will be formed and folded over by the capping machine as the cap is being applied. As an alternative option, after the trimming operation depicted in FIG. 7 is performed, the flange of the container may be subjected to a post forming step. The post forming step would in this alternative embodiment be performed by folding the sealing flange 38 over using the tooling after the container has been blow molded and trimmed and before the cap is applied. This would move the sealing flange from the slightly upwardly inclined molded position shown in FIGS. 6 and 7 to the folded-over position that is shown respectively in FIGS. 4 and 5.

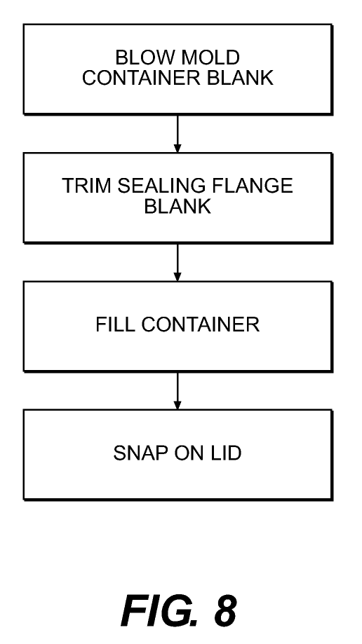

The container is then filled and sealed by snapping on the lid 18 as is shown schematically in FIG. 8. Alternatively, the lid and the container may be configured with threads to permit the lid to be screwed onto the container.

It is to be understood, however, that even though numerous characteristics and advantages of the present invention have been set forth in the foregoing description, together with details of the structure and function of the invention, the disclosure is illustrative only, and changes may be made in detail, especially in matters of shape, size and arrangement of parts within the principles of the invention to the full extent indicated by the broad general meaning of the terms in which the appended claims are expressed.

What is claimed is:

1. A blow molded plastic container, comprising:
a container main body portion; and
a lid mounting portion, said lid mounting portion comprising a sealing flange and a flexible transition portion connecting said sealing flange to said container main body portion, said flexible transition portion having at least one notch defined therein so as to form a hinge permitting downward movement of said sealing flange.

2. A blow molded plastic container according to claim 1, wherein said hinge has an average thickness that is less than about 0.025 inches.

3. A blow molded plastic container according to claim 2, wherein said hinge has an average thickness that is less than about 0.020 inches.

4. A blow molded plastic container according to claim 1, wherein said sealing flange extends radially inwardly.

5. A blow molded plastic container according to claim 1, wherein said sealing flange defines an annular, inwardly extending ring.

6. A blow molded plastic container according to claim 1, wherein said flexible transition portion comprises at least one mounting bead on an outer surface thereof for facilitating mounting of a lid to said container.

7. A blow molded plastic container according to claim 1, wherein said flexible transition portion has at least two notches defined therein so as to form at least two hinges permitting downward movement of said sealing flange.

8. A blow molded plastic container according to claim 7, wherein said at least two notches are spaced vertically from each other.

9. A blow molded plastic container according to claim 1, further comprising a lid member mounted to said container, and wherein said sealing flange creates a first circumferential seal with respect to said lid member in order to prevent leakage from said container.

10. A blow molded plastic container according to claim 9, wherein said flexible transition portion further creates a second circumferential seal with respect to said lid member in order to further prevent leakage from said container.

11. A blow molded plastic container according to claim 10, wherein said flexible transition portion comprises at least one mounting bead on an outer surface thereof, and wherein a portion of said mounting bead creates said second circumferential seal with respect to said lid member.

12. A blow molded plastic container according to claim 9, wherein said lid member has a recessed well defined in an underside thereof that may be used to hold a small amount of liquid product from the container.

13. A method of making a blow molded plastic container, comprising steps of:
blow molding a container blank having a main body portion and a lid mounting portion, said lid mounting portion comprising a sealing flange blank and a flexible transition portion connecting said sealing flange blank to said container main body portion, said flexible transition portion having at least one notch defined therein so as to form a hinge; and
trimming said sealing flange blank to form a sealing flange.

14. A method of making a blow molded plastic container according to claim 13, wherein said hinge has an average thickness that is less than about 0.025 inches.

15. A method of making a blow molded plastic container according to claim 14, wherein said hinge has an average thickness that is less than about 0.020 inches.

16. A method of making a blow molded plastic container according to claim 13, wherein said flexible transition portion comprises at least one mounting bead on an outer surface thereof for facilitating mounting of a lid to said container.

17. A method of making a blow molded plastic container according to claim 13, wherein said flexible transition portion has at least two notches defined therein so as to form at least two hinges permitting downward movement of said sealing flange.

18. A method of making a blow molded plastic container according to claim 17, wherein said at least two notches are spaced vertically from each other.
